(19) United States
(12) Patent Application Publication
(10) Pub. No.: US 2007/0021974 A1
(43) Pub. Date: Jan. 25, 2007

(54) Method, system and apparatus for matching pets to appropriate pet products and supplies

(76) Inventor: Jill Leslie Gizzio, Exton, PA (US)

Correspondence Address: PATRICIA A. WENGER, 201 NORTH JACKSON STREET, MEDIA, PA, 19063, US

(21) Appl. No.: 11/527,170

(22) Filed: Sep. 25, 2006

Related U.S. Application Data
(63) Continuation-in-part of application No. 09/881,527, filed on Jun. 14, 2001.

(51) Int. Cl. G06Q 99/00; G07G 1/14; G06Q 30/00

(52) U.S. Cl. 705/1; 705/14

(57) ABSTRACT

The present invention is a method, system and apparatus for matching pets, particularly dogs and cats, with an appropriate product by a pet owner. A breed code is assigned to each breed of pet based on predetermined criteria. Pet products and supplies are classified based on the suitability of the product for pets of various breed codes. The breed codes assigned to each breed and breed codes assigned to each product are published and made available to the consumer so that a pet owner may make an informed decision in purchasing a product for a pet. An average energy requirement is calculated for each breed code to match a dog with consumables. Standard units are calculated for the average energy requirement and the caloric content of consumables.

### RELATED APPLICATIONS

This application claims the benefit of, and is a continuation-in-part application for, Applicant's co-pending application Ser. No. 09/881,527 entitled “Method And Apparatus For Matching Pets To Appropriate Pet Products And Supplies.”

### BACKGROUND OF THE INVENTION

1. Field of the Invention

The invention is a method and apparatus allowing a consumer to select Pet products and supplies appropriate for a specific breed of domestic pet.

2. Description of the Related Art

Domestic pets of all sizes and activity levels require safe and suitable products in their daily lives. Appropriate Pet products and supplies can help to satisfy both a pet's maintenance needs and their exercise, amusement, and socialization requirements.

Many pet owners become deeply attached to their pets, and are willing to spend considerable money providing for their maintenance and care. The industry serving these pet owners is large and diverse. A significant portion of the pet industry is devoted to manufacturing supplies to maintain, nurture, amuse and occupy pets.

The diversity of Pet products and supplies for pets available on the market is matched only by the diversity of the animals themselves. Pets differ in size, personality, and exercise requirements. Products appropriate for one pet may be entirely inappropriate for another pet. The prior art provides no guidance to the pet owner as to which products are appropriate for the owner's pet. An inappropriate pet product can not be properly used by the animal and is a waste of money for the pet owner. At worst, an inappropriate pet product can present a hazard to the pet, such as an increased likelihood of the animal ingesting and choking on or experiencing intestinal blockage from the product.

The prior art does not teach a systematic classification system to assist the pet owner in determining whether a particular pet product is appropriate for the owner's pet.

### SUMMARY OF THE INVENTION

The invention includes, but is not limited to, the following methods and systems.

The invention includes a method of matching at least one dog with at least one consumable comprising the steps of: (a) assigning a breed code to a plurality of breeds of dogs based on predetermined criteria; and (b) categorizing the at least one consumable for the plurality of breeds of dog assigned to the breed code, where the categorizing of the at least one consumable further comprises ascertaining the average energy requirement for the breed code.

The invention also includes a method of matching at least one dog breed with at least one consumable comprising the steps of: (a) assigning a breed code to a plurality of breeds of dogs based on predetermined criteria; and (b) categorizing the at least one consumable for the plurality of breeds of dog assigned to the breed code, Where the categorizing of the at least one consumable further comprises ascertaining the average energy requirement for the breed code.

Further, the invention includes a system of matching at least one dog with at least one consumable comprising the steps of: (a) assigning a breed code to a plurality of breeds of dogs based on predetermined criteria; (b) categorizing at least one consumable for the plurality of breeds of dog assigned to the breed code, where the categorizing of the at least one consumable further comprises ascertaining the average energy requirement for the breed code; and (c) providing the at least one consumable.

The invention also includes a system of matching at least one dog breed with at least one consumable comprising the steps of: (a) assigning a breed code to a plurality of breeds of dogs based on predetermined criteria; (b) categorizing the at least one consumable for the plurality of breeds of dog assigned to the breed code, where the categorizing of the at least one consumable further comprises ascertaining the average energy requirement for the breed code; and (c) providing the at least one consumable.

Also, the invention includes a method of matching at least one breed code with at least one consumable comprising the steps of categorizing the at least one consumable for the breed code, where the categorizing of the at least one consumable further comprises ascertaining the average energy requirement for the breed code.

The invention also includes a system of matching at least one breed code with at least one consumable comprising the steps of: (a) categorizing the at least one consumable for the at least one breed code, the categorizing of the at least one consumable further comprising ascertaining the average energy requirement for the at least one breed code; and (b) providing at least one consumable.

The invention also includes a method of calculating standard units for at least one consumable, the method comprising: (a) determining at least one breed code for at least one breed of dog; and (b) calculating the average energy requirement for the at least one breed code.

Also, the invention is a method of manufacturing at least one consumable, the method comprising: (a) determining at least one breed code for at least one breed of dog; (b) calculating the average energy requirement for the at least one breed code; and (c) determining the caloric content in the at least one consumable.

Further, the invention includes a system of manufacturing at least one consumable, the method comprising: (a) determining at least one breed code for at least one breed of dog; (b) calculating the average energy requirement for the at least one breed code; (c) determining the caloric content in the at least one consumable; and (d) manufacturing the at least one consumable.

The invention also includes a method of matching at least one dog with at least one consumable comprising the steps of (a) assigning at least one breed code to a plurality of breeds of dogs based on predetermined criteria; (b) calculating the average energy requirement for the plurality of breeds using the average weight of adult dogs within the breed code; and (c) converting the at least one consumable into standard units.

The invention further includes a method of matching at least one dog breed with at least one consumable comprising the steps of (a) assigning at least one breed code to a plurality of breeds of dogs based on predetermined criteria; (b) calculating the average energy requirement for the plurality of breeds using the average weight of adult dogs within the breed code; and (c) converting the at least one consumable into standard units.

Also, the invention includes a method of matching at least one dog with at least one consumable comprising the steps of (a) assigning at least one breed code to a plurality of breeds of dogs based on predetermined criteria; (b) calculating the Average Energy Requirement for the plurality of breeds using a Metabolizable Energy Requirement equation that has a constant factor of 121 times the average weight of adult dogs within the at least one breed code; (c) calculating a standard unit as one percent of the average energy requirement of the at least one breed code; (d) converting the at least one consumable into standard units; and (e) providing 100 percent of the average energy requirement to the at least one dog per day.

Also, the invention includes a method of matching at least one dog breed with at least one consumable comprising the steps of: (a) assigning at least one breed code to a plurality of breeds of dogs based on predetermined criteria; (b) calculating the Average Energy Requirement for the plurality of breeds using a Metabolizable Energy Requirement equation that has a constant factor of 121 times the average weight of adult dogs within the at least one breed code; (c) calculating a standard unit as one percent of the average energy requirement of the at least one breed code; (d) converting the at least one consumable into standard units; and (e) providing 100 percent of the average energy requirement to the at least one dog breed per day.

The invention further includes a method of matching at least one dog breed with at least one consumable comprising the steps of: (a) assigning a breed code to a plurality of breeds of dogs based on predetermined criteria, where the predetermined criteria for assigning the breed code to the plurality of breeds of dog comprises assigning an exercise factor to each of the breeds of dog based on predetermined criteria, assigning a weight factor to each of the breeds of dog based on predetermined criteria, and combining the exercise factor and the weight factor in a predetermined manner to determine the breed code; (b) categorizing at least one consumable for the plurality of dog breeds assigned to the at least one breed code; and (c) publishing the assignment of the at least one breed code and the categorization of the at least one consumable to allow a consumer to match the at least one consumable to the at least one breed of dog.

Also, the invention includes a method of combining more than one consumable for daily intake by a dog, the method comprised of: (a) determining a breed code for a dog; (b) determining the average energy requirement for the breed code; (c) converting the average energy requirement into standard units; (d) determining caloric content in each of the more than one consumable; (e) converting the caloric content in each of the more than one consumable into standard units; and (f) combining the more than one consumable in a manner in which the standard units in the more than one consumable equal a predetermined value.

Still further, the invention includes a method of combining more than one consumable for daily intake by at least one dog breed, the method comprised of: (a) determining at least one breed code for the at least one dog breed; (b) determining the average energy requirement for the at least one breed code; (c) determining the caloric content in each of the more than one consumable; (d) converting the caloric content in each of the more than one consumable into standard units based on the average energy requirement; and (e) combining the more than one consumable in a manner in which the standard units in the more than one consumable equal a predetermined value.

Also, the invention includes a method of calculating the quantity of at least one consumable to provide to at least one dog for consumption daily, the method comprising: (a) ascertaining the breed code for the at least one dog based on predetermined criteria; (b) determining the average energy requirement for the breed code; (c) determining the caloric content in a quantity of the at least one consumable; and (d) dividing the average energy requirement by the caloric content of the at least one consumable.

The invention also includes a method of calculating the quantity of at least one consumable to provide to at lease one dog breed for consumption daily, the method comprising: (a) ascertaining the breed code for the at least one dog breed based on predetermined criteria; (b) determining the average energy requirement for the breed code; (c) determining the caloric content in a quantity of the at least one consumable; and (d) dividing the average energy requirement by the caloric content of the at least one consumable.

Also, the invention includes a method of calculating the quantity of at least one consumable to provide to at least one breed code for consumption daily, the method comprising: (a) determining the average energy requirement for the breed code; (b) determining the caloric content in a quantity of the at least one consumable; and (c) dividing the average energy requirement by the caloric content of the at least one consumable.

Still further, the invention includes a method of determining the average energy requirement for at least one breed code, the method comprising: (a) calculating the average weight of average adult dogs in the at least one breed code; and (b) multiplying the average weight by a metabolizable energy requirement constant factor.

### BRIEF DESCRIPTION OF THE DRAWINGS

FIG. 1 is a product attached to retail display packaging.

FIG. 2 is a retail display with breed code information.

FIG. 3 is a product marked with a breed code.

FIG. 4 illustrates a computer network implementing the present invention.

FIG. 5 is a flow chart for one method of determining breed code for dogs.

FIG. 6 is a flow chart that calculates AER by breed code.

FIG. 7 is a chart showing calorie content of standard units.

FIG. 8a is a flow chart calculating standard units by breed code.

FIG. 8b is a flow chart calculating standard units by breed code.

FIG. 9 is a flow chart showing an embodiment of calculating one type of consumable by breed code.

FIG. 10 is a chart showing an embodiment of calculating one type of consumable by breed code.

FIG. 11 is a flow chart showing an embodiment of calculating one type of consumable by breed code.

FIG. 12 is chart showing quantities of one type of a consumable totaling the AER in breed codes.

FIG. 13 is a flow chart showing an embodiment of calculating more than one type of consumable by breed code.

FIG. 14 is a chart showing an embodiment of calculating more than one type of consumable by breed code.

### DESCRIPTION OF THE PREFERRED EMBODIMENTS

“Consumable” as used herein is defined as any material ingested by or administered to a dog that has constituents (protein, carbohydrate, fat, sugar, etc.) that can be measured or expressed calorically, such as in kilocalories (kcal).

“Product” as used herein includes “consumables” as previously defined.

Indicia are assigned to a breed of pet, such a breed of dog or cat. In the preferred embodiment, the indicia comprise a numerical breed code. Pet products and supplies are categorized to determine for what pets having a breed code a product having an identical breed code is appropriate. Finally, the breed code assigned to a particular breed and list of Pet products and supplies categorized by breed code are published. Publication of the breed codes and publication of the list of Pet products and supplies categorized by breed code informs a pet owner as to whether a particular product is appropriate for a particular pet.

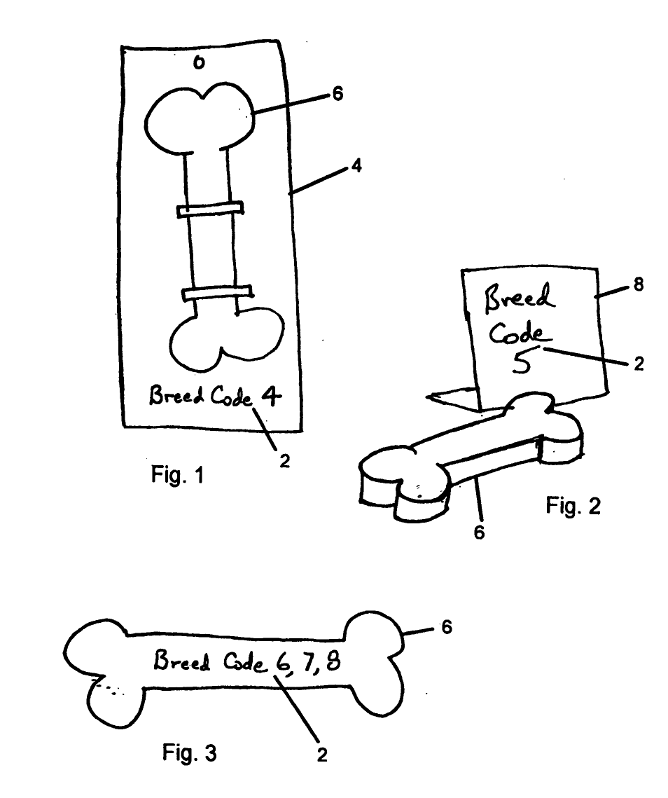

As shown by FIG. 1 the publication of the breed code categories 2 for which a product is appropriate need not appear as a list and may appear on the container or packaging 4 of a product 6. As shown by FIG. 2, the publication of the breed code categories 2 may be in the form of labeling, advertising, or any other means 8 in the proximity of a product 6. The publication of the breed code categories 2 may appear on the product itself 6 FIG. 3, as by printing, embossing or creation of a raised pattern. Also as shown by FIG. 3, a single product 6 may be suitable for pets belonging to several breed codes 2.

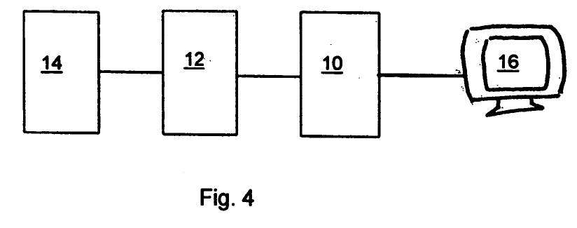

Publication of the breed codes and publication of the list of Pet products and supplies categorized by breed code may be implemented by computer or other communication device. As shown by FIG. 4, a user instructs a client computer 10 to request information from a server computer 14. The client computer 10 sends the request through a computer network 12, which may be the Internet. The server computer 14 receives the request. The server computer 14 transmits information through the computer network 12 to the client computer 10, where a display 16 exhibits the information to the user. The information transmitted by the server computer 14 to the client computer 10 may comprise the identification of a product 6 and publication of the breed codes categories 2 for which the product 6 is appropriate.

For the purposes of this application, a client computer 10 is any device capable of requesting information over a computer network 12 and displaying 16 received information to the user. For the purposes of this application, a server computer 14 is any device capable of delivering information to a client computer 10 over a computer network 12.

Any suitable method may be used to assign indicia to a breed of pet. Dogs and cats can be categorized in any of many possible ways, including without limitation: age of the animal, dimensions of various features of the animal, weight of the animal, bone structure, the size of the jaw, chewing temperament, athleticism, exercise needs, group, breed, personality characteristics, taste and odor preferences, and any other factors that assist in predicting behavior and preferences. Any such categorization is contemplated by this application. Although the present method assigns a single breed code to all pets of that breed, it is contemplated that multiple indicia could be assigned to pets of the same breed based on weight, age or other characteristics or for the purpose of matching the breed with Pet products and supplies of different types, such as chewing Pet products and supplies and fetching Pet products and supplies.

The indicia may comprise a breed code assigned to a breed and an identical breed code used to designate an appropriate product. The indicia assigned to the breed and the product may not be identical, but may correspond one to another; as, for example and without limitation, a first color assigned to a breed and a second color assigned to Pet products and supplies appropriate for pets of that breed.

For the purposes of this application, a “breed” of pet, such as a dog or cat, is a relatively homogenous group of animals identified by experts. Pets of a particular breed, such as breeds of dog recognized by the American Kennel Club, share characteristics of weight, jaw size and shape, activity level and personality characteristics. The breed of a dog provides a reasonable estimation of the needs of that dog. A pet product appropriate to one dog of a particular breed likely will be appropriate to most dogs of the same breed.

The starting point for the determination of breed codes for dogs is identifying the breed and determining the weight and exercise requirements of each breed of dog. The “breeds” of dog are those recognized by the American Kennel Club. The weight of each breed is the ideal weight of an adult dog of the breed as published by the American Kennel Club. The exercise requirement is based on information obtained from published sources; namely the Encyclopedia of Dogs by D. Caroline Coile, Ph.D., published by Barron's, ISBN 0-7641-5097-0, and is based on the activity expected from typical dogs of each breed.

An exercise factor is derived for each breed of dogs, as shown by Table 1. The exercise requirement is an assigned value of 1 through 5, with one being a very low exercise requirement and five being a very high exercise requirement. The exercise factor is derived from the exercise requirement.

TABLE 1

| Exercise | Exercise |
|---|---|
| Requirement | Factor |
| 0-1 | 1 |
| 2-5 | 2 |

A weight factor is derived based on the ideal weight for an adult dog of the breed as shown in Table 2. As an example and as shown on Table 2, a breed of dog with an ideal adult weight of 10 pounds is assigned a weight factor of 0.

TABLE 2

| Weight | Weight |
|---|---|
| In lbs. | Factor |
| 0-10 | 0 |
| 11-16 | 2 |
| 17-35 | 3 |
| 36-45 | 4 |
| 46-70 | 5 |
| 71-80 | 6 |
| 81 and | 7 |
| above | |

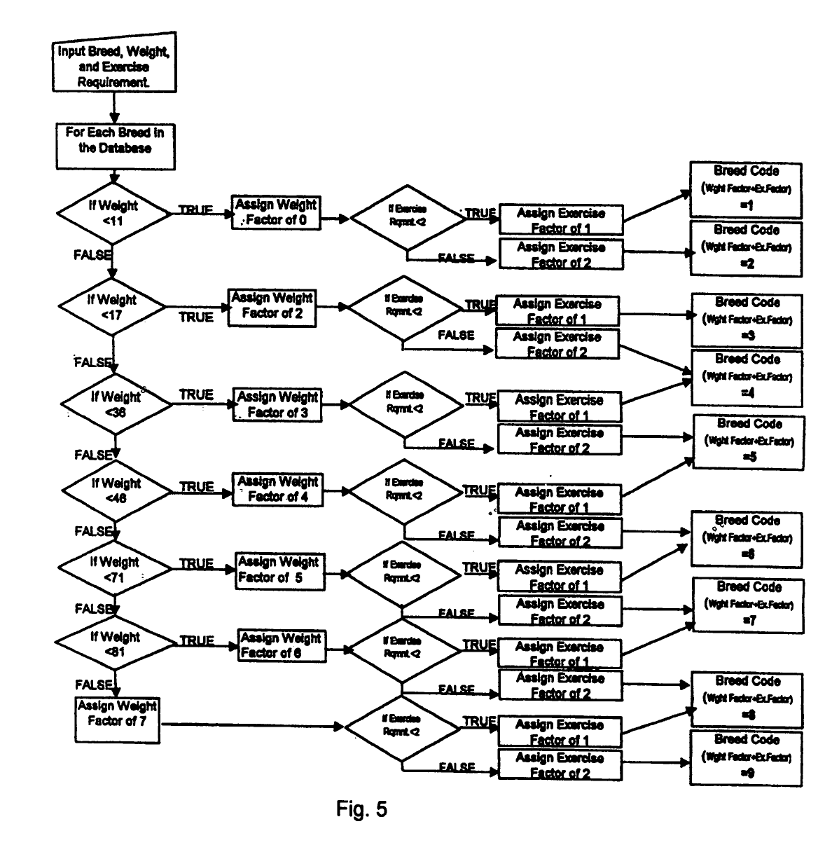

To calculate the breed code for a breed of dog, the exercise factor for that breed is added to the weight factor for the breed. The sum is the breed code. FIG. 5 is a flow chart showing the calculation of breed codes by summing the exercise factor and the weight factor. Each breed is entered into the database. The weight of each breed is entered into the database. Average weight values for breed codes may reflect a variance of +/−5% due to the rounding of average weights of each dog breed within a breed code. The weight of each breed is converted into a weight factor and retained in the database. The exercise requirement for each breed is entered into the database. The exercise requirement is converted into an exercise factor and combined with the weight factor to yield the breed code. Table 3 below is the result of the summation of exercise factor and weight factor for several breeds of dogs recognized by the American Kennel Club. Included in Table 3 are the breed, group name, weight, activity requirement, exercise factor, weight factor and resulting breed code. The breeds are grouped in the table by breed code.

TABLE 3
Breed Code Determination

| | | | | | |
|---|---|---|---|---|---|
| | | | | Exercise | Weight |
| Breed | Group | Weight | Exercise | Factor | Factor |

Breed Code: 1

| | | | | | |
|---|---|---|---|---|---|
| Chihuahua | Toy | 5 | 1 | 1 | 0 |
| Colon De Tulear | Toy | 8 | 1 | 1 | 0 |
| English Toy Spaniel | Toy | 10 | 1 | 1 | 0 |
| Japanese Chin | Toy | 5 | 1 | 1 | 0 |
| Maltese | Toy | 5 | 1 | 1 | 0 |
| Papillon | Toy | 10 | 1 | 1 | 0 |
| Pekingese | Toy | 10 | 1 | 1 | 0 |
| Pomeranian | Toy | 5 | 1 | 1 | 0 |

Breed Code: 2

| | | | | | |
|---|---|---|---|---|---|
| Affenpinscher | Toy | 9 | 3 | 2 | 0 |
| American Eskimo Toy | Non-Sporting | 8 | 3 | 2 | 0 |
| Bichon Frise | Non-Sporting | 10 | 2 | 2 | 0 |
| Brussels Griffon | Toy | 9 | 2 | 2 | 0 |
| Chinese Crested | Toy | 8 | 2 | 2 | 0 |
| Dachshund Mini & Toy | Toy | 10 | 2 | 2 | 0 |
| Fox Terrier -Toy | Toy | 5 | 3 | 2 | 0 |
| Manchester Terrier Toy | Toy | 8 | 2 | 2 | 0 |
| Miniature Pinscher | Toy | 9 | 2 | 2 | 0 |
| Schipperke mini | Toy | 10 | 3 | 2 | 0 |
| Silky Terrier | Toy | 10 | 2 | 2 | 0 |
| Toy Poodle | Toy | 6 | 2 | 2 | 0 |
| Yorkshire Terrier | Toy | 7 | 2 | 2 | 0 |

Breed Code: 3

| | | | | | |
|---|---|---|---|---|---|
| Lhasa Apso | Non-Sporting | 14 | 1 | 1 | 2 |
| Lowchen | Non-Sporting | 15 | 1 | 1 | 2 |
| Pug | Toy | 16 | 1 | 1 | 2 |
| Shih Tzu | Toy | 13 | 1 | 1 | 2 |

Breed Code: 4

| | | | | | |
|---|---|---|---|---|---|
| American Eskimo Mini | Non-Sporting | 15 | 3 | 2 | 2 |
| Australian Terrier | Terrier | 12 | 3 | 2 | 2 |
| Border Terrier | Terrier | 15 | 3 | 2 | 2 |
| Boston Terrier | Non-Sporting | 20 | 1 | 1 | 3 |
| Bulldog French *special need | Non-Sporting | 25 | 1 | 1 | 3 |
| Cairn Terrier | Terrier | 14 | 3 | 2 | 2 |
| Cavalier King Charles Spaniel | Toy | 15 | 3 | 2 | 2 |
| Havanese *wght | Toy | 13 | 3 | 2 | 2 |
| Italian Greyhound | Toy | 13 | 2 | 2 | 2 |
| Jack Russell Terrier | Terrier | 15 | 4 | 2 | 2 |
| Miniature Schnauzer | Terrier | 14 | 3 | 2 | 2 |
| Norfolk Terrier | Terrier | 12 | 3 | 2 | 2 |
| Norwich Terrier | Terrier | 12 | 3 | 2 | 2 |
| Poodle mini | Non-Sporting | 15 | 3 | 2 | 2 |
| Schipperke | Non-Sporting | 15 | 3 | 2 | 2 |
| Tibetan Spaniel | Non-Sporting | 12 | 2 | 2 | 2 |

Breed Code: 5

| | | | | | |
|---|---|---|---|---|---|
| American Eskimo Dog | Non-Sporting | 30 | 3 | 2 | 3 |
| Basenji | Hound | 25 | 3 | 2 | 3 |
| Basset Hound | Hound | 45 | 1 | 1 | 4 |
| Beagle | Hound | 25 | 3 | 2 | 3 |
| Bedlington Terrier | Terrier | 20 | 3 | 2 | 3 |
| Bulldog English *special need | Non-Sporting | 45 | 1 | 1 | 4 |
| Cardigan Welsh Corgi | Herding | 35 | 2 | 2 | 3 |
| Cocker Spaniel | Sporting | 30 | 3 | 2 | 3 |
| Dachshund *wght | Hound | 30 | 2 | 2 | 3 |
| Dandie Dinmont Terrier | Terrier | 21 | 3 | 2 | 3 |
| English Cocker Spaniel | Sporting | 35 | 3 | 2 | 3 |
| Finnish Spitz | Non-Sporting | 30 | 3 | 2 | 3 |
| Fox TerrierSmooth&Wire | Terrier | 20 | 3 | 2 | 3 |
| Foxhound American | Hound | 24 | 4 | 2 | 3 |
| Irish Terrier | Terrier | 25 | 3 | 2 | 3 |
| Lakeland Terrier | Terrier | 20 | 3 | 2 | 3 |
| Manchester Terrier terrier | Terrier | 22 | 3 | 2 | 3 |
| Miniature Bull Terrier | Terrier | 29 | 3 | 2 | 3 |
| Pembroke Welsh Corgi | Herding | 25 | 3 | 2 | 3 |
| Petit Basset Griffon Vendeen | Hound | 35 | 3 | 2 | 3 |
| Puli | Herding | 30 | 3 | 2 | 3 |
| Scottish Terrier | Terrier | 20 | 3 | 2 | 3 |
| Sealyham Terrier | Terrier | 23 | 2 | 2 | 3 |
| Shetland Sheepdog | Herding | 20 | 3 | 2 | 3 |
| Shiba Inu | Non-Sporting | 25 | 3 | 2 | 3 |
| Skye Terrier | Terrier | 20 | 2 | 2 | 3 |
| Soft Coated Wheaten Terrier | Terrier | 35 | 3 | 2 | 3 |
| Staffordshire Bull Terrier | Terrier | 35 | 3 | 2 | 3 |
| Tibetan Terrier | Non-Sporting | 25 | 3 | 2 | 3 |
| Welsh Terrier | Terrier | 35 | 3 | 2 | 3 |
| West Highland White Terrier | Terrier | 20 | 3 | 2 | 3 |
| Whippet | Hound | 30 | 3 | 2 | 3 |

Breed Code: 6

| | | | | | |
|---|---|---|---|---|---|
| Airedale Terrier | Terrier | 45 | 3 | 2 | 4 |
| American Water Spaniel | Sporting | 40 | 3 | 2 | 4 |
| Australian Cattle Dog | Herding | 40 | 5 | 2 | 4 |
| Border Collie | Herding | 40 | 5 | 2 | 4 |
| Brittany | Sporting | 40 | 5 | 2 | 4 |
| Field Spaniel | Sporting | 45 | 4 | 2 | 4 |
| Ibizan Hound | Hound | 45 | 3 | 2 | 4 |
| Keeshond | Non-Sporting | 40 | 3 | 2 | 4 |
| Kerry Blue Terrier | Terrier | 40 | 3 | 2 | 4 |
| Norwegian Elkhound | Hound | 45 | 3 | 2 | 4 |
| Schnauzer Standard | Working | 40 | 3 | 2 | 4 |
| Sussex Spaniel | Sporting | 40 | 3 | 2 | 4 |
| Welsh Springer Spaniel | Sporting | 45 | 3 | 2 | 4 |

Breed Code: 7

| | | | | | |
|---|---|---|---|---|---|
| Afghan Hound | Hound | 60 | 3 | 2 | 5 |
| American Staffordshire | Terrier | 60 | 3 | 2 | 5 |
| Australian Shepherd | Herding | 50 | 5 | 2 | 5 |
| Bearded Collie | Herding | 50 | 4 | 2 | 5 |
| Belgian Malinois | Herding | 65 | 5 | 2 | 5 |
| Belgian Sheepdog same | Herding | 65 | 5 | 2 | 5 |
| Boxer | Working | 65 | 3 | 2 | 5 |
| Bull Terrier | Terrier | 55 | 3 | 2 | 5 |
| Canaan Dog | Herding | 50 | 4 | 2 | 5 |
| Chesapeake Bay Retriever | Sporting | 70 | 3 | 2 | 5 |
| Chinese Shar-pei | Non-Sporting | 55 | 3 | 2 | 5 |
| Chow Chow | Non-Sporting | 60 | 2 | 2 | 5 |
| Clumber Spaniel | Sporting | 60 | 2 | 2 | 5 |
| Collie | Herding | 65 | 3 | 2 | 5 |
| Curly-Coated Retriever | Sporting | 70 | 3 | 2 | 5 |
| Dalmatian | Non-Sporting | 55 | 3 | 2 | 5 |
| English Setter | Sporting | 65 | 4 | 2 | 5 |
| English Springer Spaniel | Sporting | 50 | 4 | 2 | 5 |
| Flat-Coated Retriever | Sporting | 70 | 3 | 2 | 5 |
| Foxhound English | Hound | 65 | 4 | 2 | 5 |
| German Shorthaired Pointer | Sporting | 70 | 5 | 2 | 5 |
| German Wirehaired Pointer | Sporting | 60 | 5 | 2 | 5 |
| Golden Retriever | Sporting | 70 | 3 | 2 | 5 |
| Gordon Setter | Sporting | 70 | 4 | 2 | 5 |
| Greyhound | Hound | 65 | 3 | 2 | 5 |
| Harrier | Hound | 55 | 4 | 2 | 5 |
| Irish Setter | Sporting | 55 | 5 | 2 | 5 |
| Irish Water Spaniel | Sporting | 55 | 3 | 2 | 5 |
| Italian Spinoni | Sporting | 70 | 3 | 2 | 5 |
| Labrador Retriever | Sporting | 70 | 3 | 2 | 5 |
| Pharaoh Hound | Hound | 55 | 4 | 2 | 5 |
| Plott Hound | Hound | 65 | 3 | 2 | 5 |

Breed Code: 7

| | | | | | |
|---|---|---|---|---|---|
| Pointer | Sporting | 60 | 4 | 2 | 5 |
| Poodle standard | Non-Sporting | 50 | 4 | 2 | 5 |
| Portuguese Water Dog | Working | 55 | 4 | 2 | 5 |
| Saluki | Hound | 60 | 3 | 2 | 5 |
| Samoyed | Working | 55 | 3 | 2 | 5 |
| Siberian Husky | Working | 50 | 4 | 2 | 5 |
| Vizsla | Sporting | 65 | 3 | 2 | 5 |
| Weimaraner | Sporting | 70 | 5 | 2 | 5 |
| Wirehaired Pointing Griffon | Sporting | 60 | 4 | 2 | 5 |

Breed Code: 8

| | | | | | |
|---|---|---|---|---|---|
| Alaskan Malamute | Working | 80 | 4 | 2 | 6 |
| Black and Tan Coonhound | Hound | 75 | 4 | 2 | 6 |
| Doberman Pinscher | Working | 80 | 3 | 2 | 6 |
| Komondor | Working | 75 | 3 | 2 | 6 |
| Old English Sheepdog | Herding | 80 | 3 | 2 | 6 |
| Rhodesian Ridgeback | Hound | 80 | 3 | 2 | 6 |
| Schnauzer Giant | Working | 80 | 4 | 2 | 6 |

Breed Code: 9

| | | | | | |
|---|---|---|---|---|---|
| Akita | Working | 90 | 3 | 2 | 7 |
| Anatolian Shepherd | Working | 120 | 3 | 2 | 7 |
| Bernese Mountain Dog | Working | 100 | 2 | 2 | 7 |
| Bloodhound | Hound | 100 | 3 | 2 | 7 |
| Borzoi | Hound | 85 | 3 | 2 | 7 |
| Bouvier Des Flandres | Herding | 85 | 4 | 2 | 7 |
| Briard | Herding | 85 | 4 | 2 | 7 |
| Bullmastiff | Working | 120 | 2 | 2 | 7 |
| German Shepherd Dog | Herding | 85 | 4 | 2 | 7 |
| Great Dane | Working | 110 | 3 | 2 | 7 |
| Great Pyrenees | Working | 90 | 3 | 2 | 7 |
| Great Swiss Mountain Dog | Working | 110 | 3 | 2 | 7 |
| Irish Wolfhound | Hound | 110 | 3 | 2 | 7 |
| Kuvasz | Working | 100 | 4 | 2 | 7 |
| Mastiff | Working | 180 | 2 | 2 | 7 |
| Newfoundland | Working | 150 | 2 | 2 | 7 |
| Otterhound | Hound | 90 | 3 | 2 | 7 |
| Rottweiler | Working | 110 | 3 | 2 | 7 |
| Saint Bernard | Working | 165 | 2 | 2 | 7 |
| Scottish Deerhound | Hound | 90 | 3 | 2 | 7 |

As illustrated by Table 3, the characteristics of pets of a particular breed are determined in part by the purpose for which a particular breed was originally developed. For dogs, those purposes are divided into seven groups, as follows.

a. Dogs of the sporting group were bred for hunting and retrieving. Dogs of this group have a keen sense of smell and may be swimmers.

b. The hound group includes two branches. The sight hounds were bred for sighting and chasing prey. Scent hounds, which tend to be larger dogs, were bred to locate prey by scent.

c. The working group includes guard dogs, military dogs, pack dogs, life-saving dogs, fighting dogs, police dogs, companion dogs and sled dogs.

d. Dogs of the terrier group were bred for hunting prey in burrows.

e. The Toy group includes dogs bred for size as companion dogs. Dogs of this group were derived from the hound, sporting and terrier groups.

f. The non-sporting group is a catch all for dogs not included in the other groups.

g. The herding group was bred for assistance in corralling animals and protecting them from predators.

A breed code may be assigned for a breed of cat. A temperament factor is assigned to each breed based on the characteristics of the breed; namely, the activity level of the breed. A cat's need-for-attention factor also is assigned to each breed based on the characteristics of the breed. The need-for-attention of the breed is based on the need of cats in the breed for interaction with humans. The temperament factor and need-for-attention factor are summed to obtain the breed code for a breed of cat.

### Consumables for Dogs

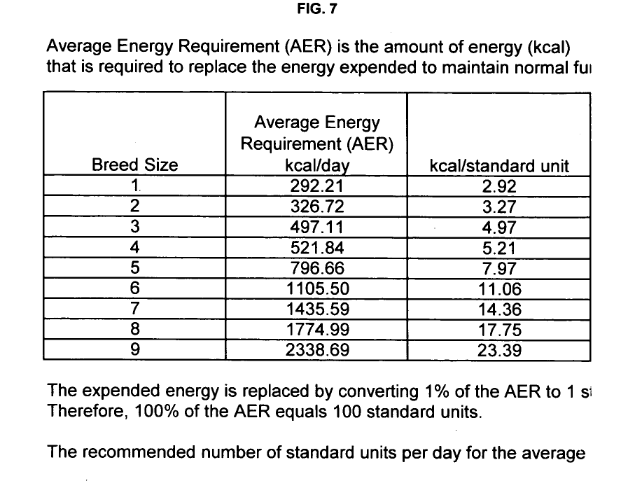

Other embodiments of the invention include utilizing at least one breed code in conjunction with the average energy requirement for each of the at least one breed codes for consumables for dogs. A “consumable” is defined as any material ingested by or administered to a dog that has constituents (protein, carbohydrate, fat, sugar, etc.) that can be measured or expressed calorically, such as in kilocalories (kcal). It is to be noted that the utilization in FIGS. 7 through 14 of a food product or products are for exemplary purposes only and are not intended to be limiting. All kinds of consumables containing all varieties of caloric content are intended to be included.

### Average Metabolizable Energy Requirement

It is well known in the art that the Metabolizable Energy Requirement (sometimes referred to as “MER”) for a dog has been defined generally as the daily number of kilocalories required to be consumed by a dog to maintain its weight. A dog's metabolic rate is the energy expended by its body at rest to maintain normal functions. It is measured in calories or kilocalories (1 kilocalorie=1,000 calories.) Two respected and qualified sources: 1) UC Davis School of Veterinary Medicine, and 2) Canine Life Stages; by Waltham Centre for Pet Nutrition (1999), Canine life stages/lifestyles. Waltham Course on Dog and Cat Nutrition (References: Burger, I. H., & Johnson, J. V. (1991). Dogs large and small: The algometry of energy requirements within a single species.) The Journal of Nutrition, 121: S18-S21, have calculated MER as the body weight of a dog multiplied by a constant factor.

Specifically, Canine Life Stages, calculates MER as 110 times the body weight in kilograms of the dog, and UC Davis calculates MER as 132 times the body weight in kilograms of the dog. These MER calculations, which are well-known in the art, calculate MER in kilocalories.

An embodiment of the current invention calculates the average energy requirement (sometimes referred to as “AER”) for each breed code as the daily caloric content required to be consumed by a dog in the breed code to provide for the energy expended by the dog's body at rest to maintain its normal functions. Explained another way, an embodiment of the current invention calculates the average energy requirement (sometimes referred to as “AER”) for each breed code as the daily caloric content required to be consumed by a dog in the breed code to replace the energy expended by the dog's body at rest to maintain its normal functions. The current invention calculates AER for each breed code as the average body weight for adult dogs in the breed code multiplied by a Metabolizable Energy Requirement constant factor. In one embodiment, the weight of each breed is the ideal weight of an adult dog of the breed as published by the American Kennel Club. The ideal weight for each breed in a breed code is averaged to create one average weight value for each breed code (referred to as “breed code average weight value”), and that breed code average weight value is then multiplied by a Metabolizable Energy Requirement constant factor to create the AER. It is understood that while the ideal weight of an adult dog of the breed as published by the American Kennel Club is a reliable and valid source for ascertaining the ideal weight of an adult dog in a breed, other reliable and valid sources currently known and to be discovered could also be used.

One embodiment of the current invention utilizes a Metabolizable Energy Requirement constant factor of 121, which is the average of the constant factor of 110 used by Canine Life Stages and the constant factor of 132 used by UC Davis. Accordingly, in this embodiment, 121 is the constant factor by which the breed code average weight value, in kilograms, for each breed code is multiplied to create the average energy requirement in kilocalories. However, it is to be understood, that since Canine Life Stages and UC Davis use similar constant factors, other embodiments of the invention could use constant factors between about 110 and 132.

In addition, although kilograms and kilocalories are the standard units used in the art to determine MER, it is to be understood, that the MER calculation known in the art could easily be converted into units other than kilocalories, based on kilograms. In a similar manner, therefore, it is intended that the AER utilized in the current invention could use units other than kilocalories and kilograms, while still maintaining the intent of the invention. For example, and not intending to be limiting, pounds and calories could be used instead of kilograms and kilocalories, by making the appropriate conversions of the units utilized in the well-known MER calculations. If the conversion changed the constant factors known in the art from 110 and 132, the constant factor utilized in for the AER would be similarly adjusted. In addition, and by way of example only, while generally AER is expressed in kilocalories based on weight in kilograms, it could be expressed in calories based on weight in pounds while still maintaining the intent of the invention.

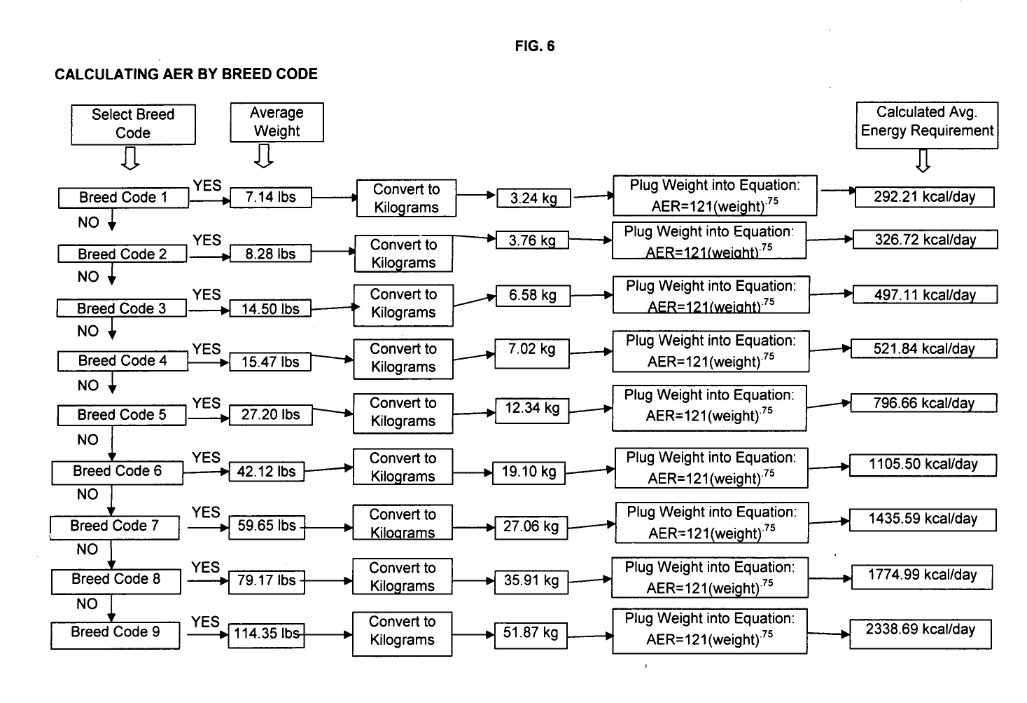

Reference is now made to FIG. 6, which is a flow chart that calculates AER by breed code. As may be seen in this Figure, the method includes determining the appropriate breed code, and determining the average body weight for adult dogs in the breed code. Thereafter, the method includes multiplying the average body weight by a constant factor to reveal the AER for the breed code. In this Figure, the AER is shown in kilocalories per day. In addition, in this Figure, the average body weight is converted to kilograms and the constant factor is 121. However as explained above, the weight and/or the caloric unit could be express in other standard units, as long as the constant factor were adjusted accordingly, if required.

As may be seen in FIG. 6, the AER, expressed in kilocalories, for the Breed Codes listed are as follows: Breed Code 1=292.21; Breed Code 2=326.72; Breed Code 3=497.11; Breed Code 4=521.84; Breed Code 5=796.66; Breed Code 6=1105.50; Breed Code 7=1435.59; Breed Code 8=1774.99; Breed Code 9=2338.69. The AER for the different breed codes are different because the breed code average weight value within the different breed codes vary.

It is to be understood that the AER for all dogs within the same breed code will be the same. This is because the same breed code average weight value is used for all the dogs within the breed code, and the breed code average weight value is then multiplied by the constant factor.

### Standard Units

An embodiment of the current invention further calculates standard units for each breed code based on the AER of each breed code. Transforming the AER into standard units enables the user of the method to easily calculate how many units at least one animal in the breed code may consume daily to provide its AER. In addition, transforming the AER into standard units enables the user of the method to easily calculate how many units at least one dog breed in a breed code may consume daily to provide the dog breed's AER. Further, transforming the AER into standard units enables the user of the method to easily calculate how many units at least one breed code may consume daily to provide the breed code's AER. The standard unit may be any standard unit.

The use of standard units are beneficial to consumers by ways including, but not limited to the following: assisting them in identifying how much to feed their dogs, providing consumers with a system for maintaining their dogs' body weights, and helping consumers to identify the appropriate quantity of food to maintain their dogs' weights.

In addition, as may be clearly understood, the benefits of this method are numerous to manufacturers, including, but not limited to, the following: 1) the standard units create a classification method and system which enables dog consumables manufacturers to speak a universal language to the consumer regarding the appropriate quantity to administer to their dog, based on their dog's breed; 2) by using the standard units method and system, the manufacturer customizes its serving suggestions by dog breed appropriateness, and as a result, consumers benefit by understanding how much of a variety or combination of consumables to administer to their dogs; 3) using the standard units method and system benefits the manufacturer by aligning the breed population with demand for the product. This demarcation of breed population assists the manufacturer in various decisions—including investment capital, research and development, and production to name a few. If the manufacturer suggests “what to buy”, the resulting production and forecasting data should be predictable; 4) the standard units method and system benefits the retailer by providing predictable consumer buying behavior. Because the store is stocked with the correct product mix in correlation to the breed population demand, the right products are in stock resulting in more turns; and 5) the standard units method and system sets a new standard for dog consumables merchandising by providing accurate, trusted information and structure to retail store environments. It provides a reliable method and system for dispensing information encouraging consumers to increase their transaction amounts. Cross-selling and up-selling occur pursuant to the standard units method and system, while at the same time enabling retail store employees to make reliable, consistent recommendations to the consumer.

Reference is now made to FIG. 7. This figure illustrates one embodiment of the invention in which one percent (1%) of the AER equals one standard unit. Or described in another way, each standard unit is 1/100th of the AER each breed code. Still further, in this embodiment, each dog in each breed code may have 100 units per day to provide its AER. Also, in this embodiment, each dog breed in each breed code may have 100 units per day to provide its AER. Further, in this embodiment, each breed code may have 100 units per day to provide its AER.

As seen in FIG. 7, one standard unit represents a different number of kilocalories for each breed code. This is because the AER is different for each Breed Code. However, one standard unit represents the same number of kilocalories for all dogs in the same breed code. While the embodiment illustrated in FIG. 7 calculates one standard unit to be one percent of the AER, it is to be understood that in other embodiments, the standard units could be any percentage as long as the percentage used is consistent for all breed codes.

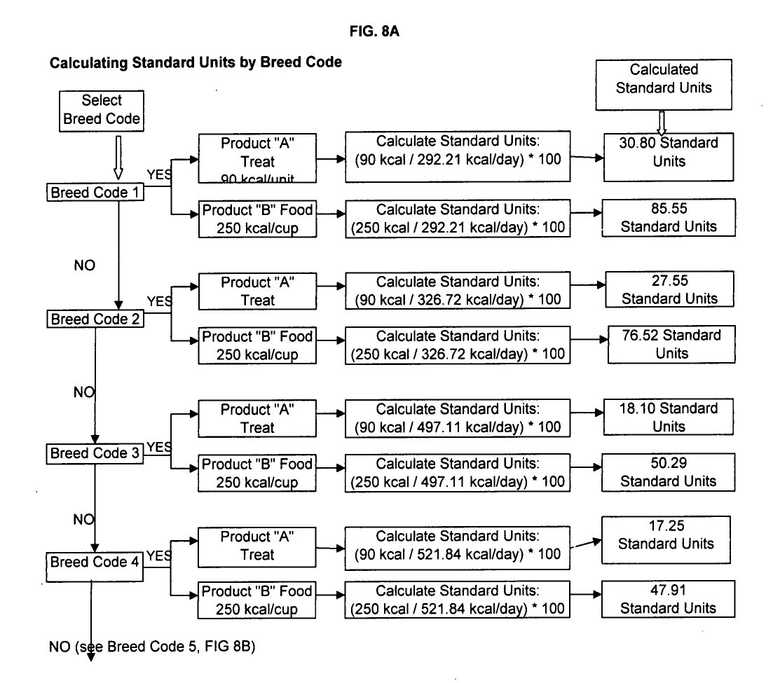

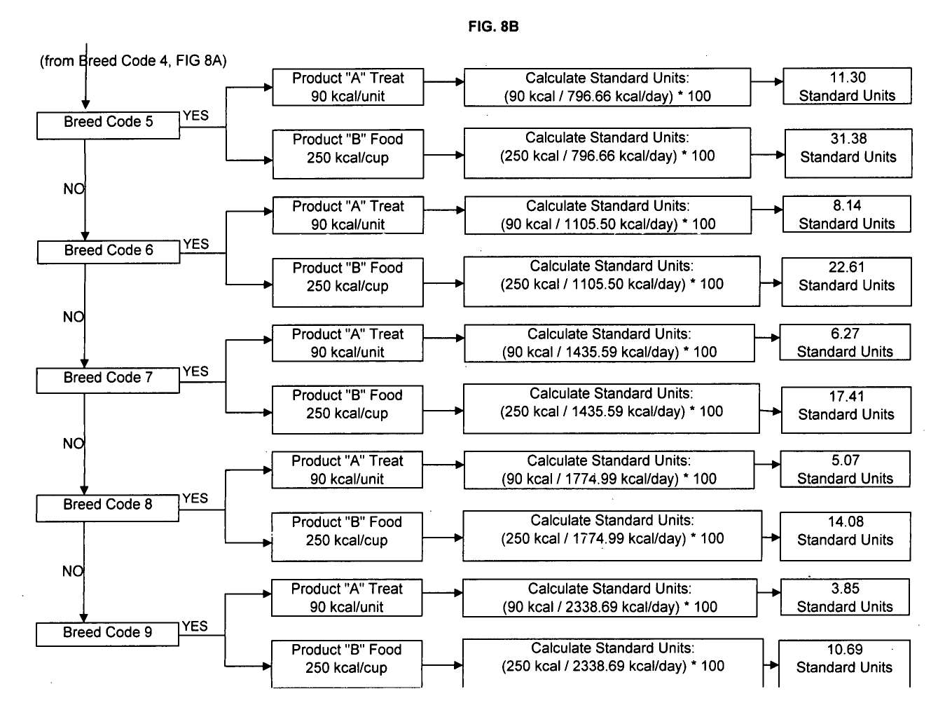

Reference is now made to FIGS. 8a and 8b, in which the number of standard units to be attributed to at least one consumable are calculated. It is to be noted that the utilization in FIGS. 8a and 8b of a product (product A) each having 90 kilocalories and a product (product B) having 250 kcal per cup are for exemplary purposes only and are not intended to be limiting. All kinds of consumables containing all varieties of caloric content are intended to be included.

As seen in reference to FIGS. 8a and 8b, to calculate the standard units for at least one consumable for each breed code, the kilocalories for the unit or quantity of the consumable is ascertained by means well known in the art. Then, the kilocalories of the unit or quantity of the consumable are divided by the AER for the breed code, and thereafter multiplied by 100. As may be seen by the examples in FIGS. 8a and 8b, the same consumable will represent different numbers of standard units for different breed codes. This is because the standard units in the different breed codes represent different numbers of kilocalories. However, the same consumable represents the same number of standard units for all dogs in the same breed code.

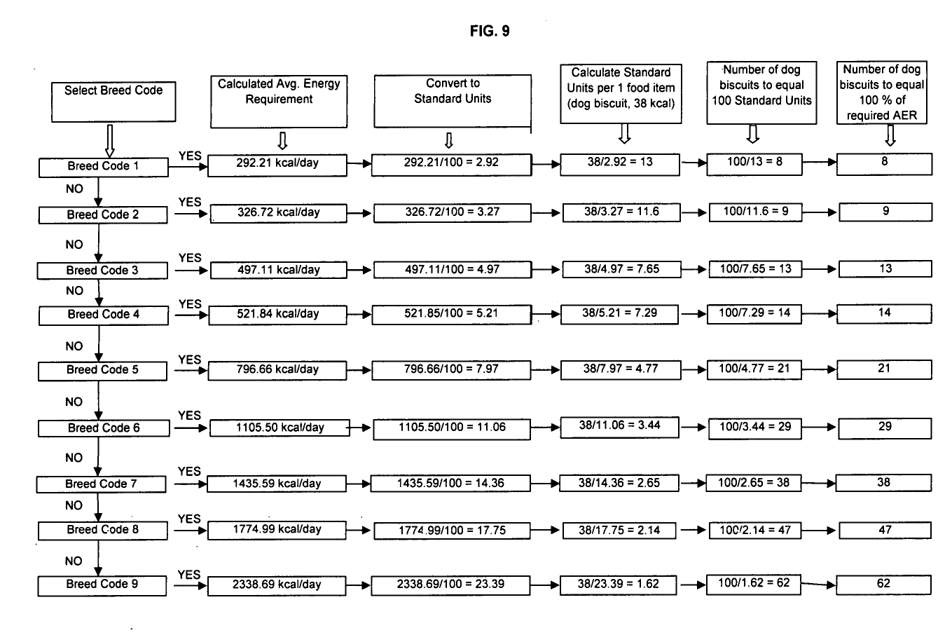

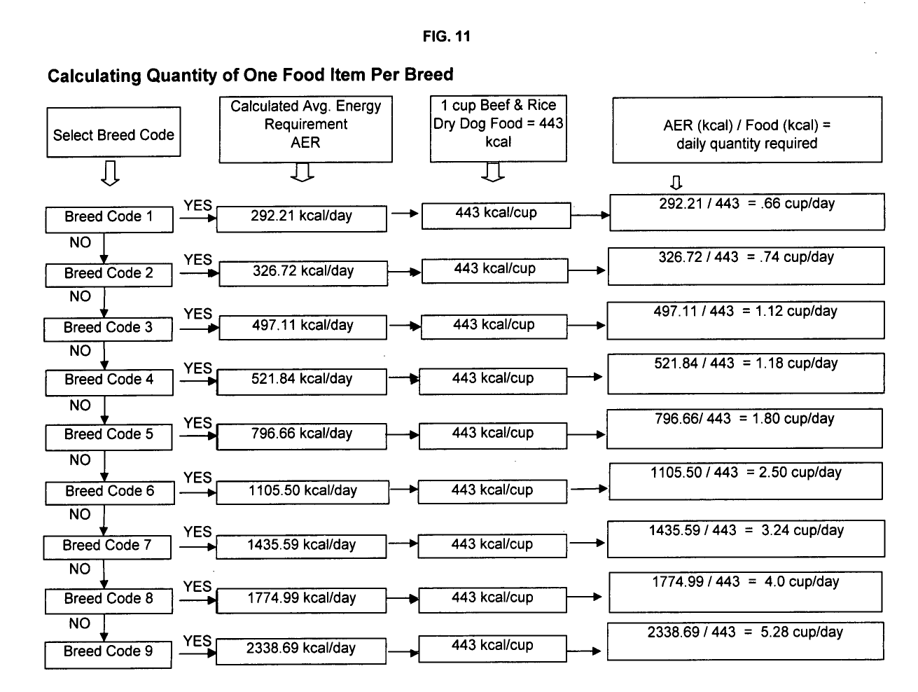

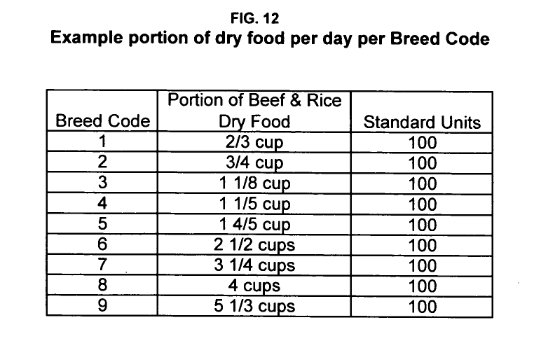

Reference is now made to FIGS. 9 through 12. These Figures illustrate that by using standard units for the breed codes, the amount of a particular consumable to give to a dog in a particular breed code may be calculated. The example used in FIGS. 11 and 12 is dry dog food for which one cup has 443 kilocalories. As may be seen in the embodiment illustrated in FIG. 11, to calculate the amount of the consumable (dry dog food) to feed a dog daily in a particular breed code, the kilocalories (443) per quantity (1 cup) is calculated by means well known in the art, the appropriate breed code is ascertained, the AER for the appropriate breed code is ascertained, and the AER is divided by kilocalories per quantity of the consumable. The resulting FIG. 12 clearly shows the amount of the particular food a dog in a breed code may eat daily to provide its AER. The daily amount of the consumable that a dog in the different breed codes may consume varies because the AER for the different breed codes vary. Predictably, in the examples shown in FIGS. 11 and 12, as the AER for the breed codes increases, the amount of the consumable that may be consumed daily increases.

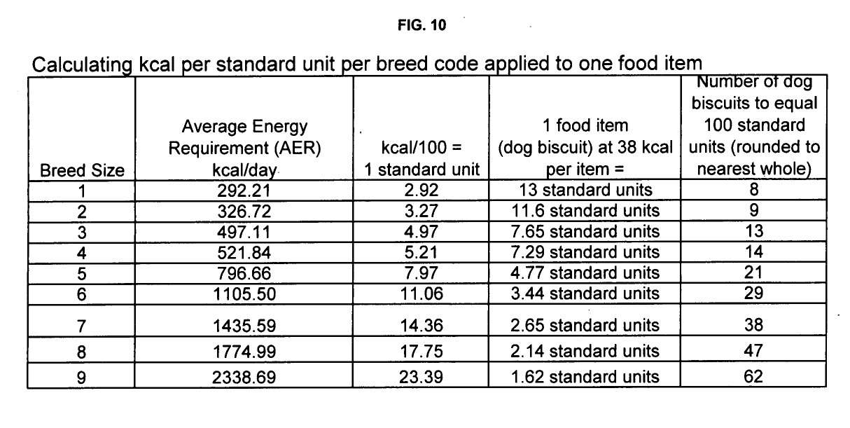

Alternatively, while utilizing the embodiments and examples included in FIGS. 9 and 10, by using the standard units for the breed codes, the amount of a particular food to feed a dog in a particular breed code may be calculated. In this embodiment, the AER for each breed code is calculated. Then, the kilocalories per standard unit is calculated. In the examples illustrated in FIGS. 9 and 10, one standard unit equals one one-hundredth of the AER, so one one-hundredth of the AER equals one standard unit. Thereafter the caloric content of the consumable is divided by the standard unit to determine standard units per consumable. Then 100 (the predetermined number of standard units to equal the AER) is divided by the number of standard units per consumable. The result indicates the number of daily portions of the consumable that will provide the AER for each of at least one dog within the breed code. The daily number of portions of the consumable to provide the AER will be the same for all dogs within the same breed code.

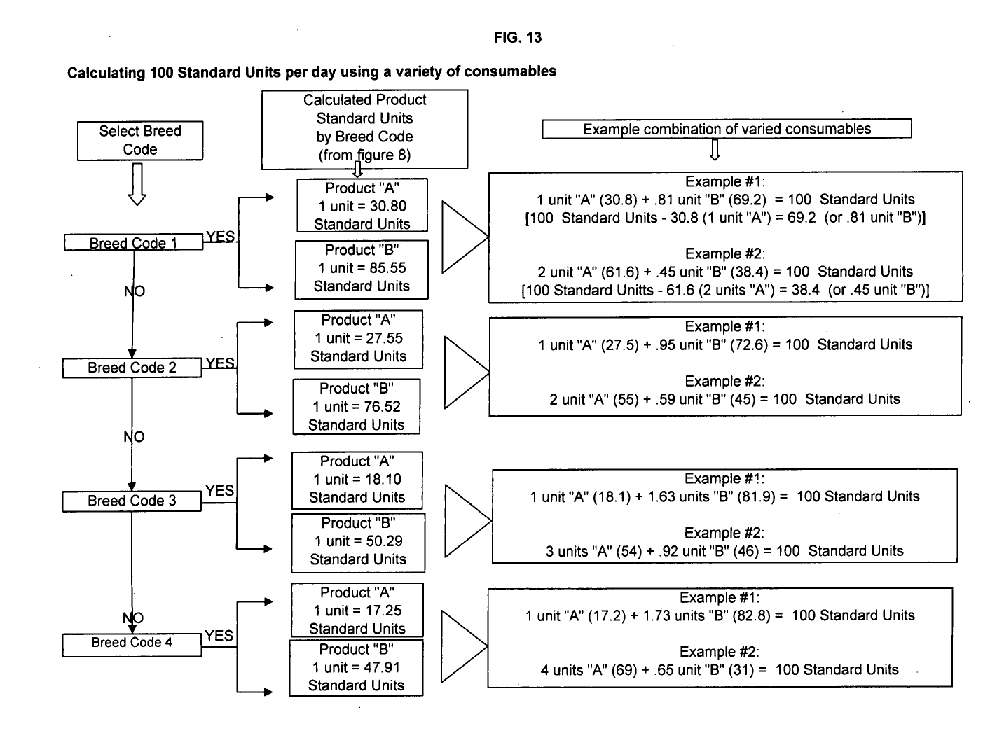

As illustrated in FIGS. 8a, 8b, 13 and 14, the standard units for the breed codes may be used to determine the amount of a combination of more that one type of consumable to provide a dog in a particular breed code to provide the dog's AER. As previously described, and as illustrated in FIGS. 8a and 8b, standard units for each consumable within the various breed codes may be determined. Now referring specifically to FIG. 13 in conjunction with FIGS. 8a and 8b, the combination of consumables, for example, food product(s) and/or quantity or quantities of food item(s), to provide the AER may be determined by adding the standard units in the different types or quantities of consumables to equal a predetermined value. The predetermined value will create the number of standards units required to provide the AER. In this embodiment, the predetermined value is 100, and each standard unit is one one-hundredth of the amount needed for the AER. However, it is to be understood that in this embodiment, other standard units could be used as long as (as previously described) the standard units calculation is consistent for all breed codes, and the predetermined number of standard units used add up to the amount of caloric content needed to provide the AER.

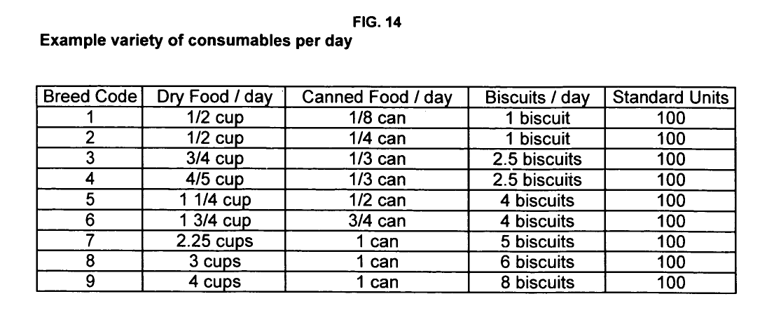

As may be seen by the examples in FIG. 14, different combinations of consumables are needed for the different breed codes. This is because, as previously described, the AER and the caloric content in each standard unit is different in each breed code. However, to provide the AER, the same daily combination of consumables may be used for each dog in the same breed code.

While many of the embodiments of the invention contemplate daily providing a dog with one hundred percent of its AER, it is to be understood, that providing close to 100 percent of the AER is also contemplated in the invention. This is because, among other reasons, some embodiments of the invention use numbers rounded to the nearest whole (see FIG. 9 for examples) and providing exactly 100 percent of the AER may be difficult to accomplish, particularly if a combination of consumables is used.

As will be easily appreciated, the embodiments of the foregoing methods and systems described relating to the use of an AER for at least one breed code, may be used in a variety of ways, including but not limited to: matching at least one dog with at least one consumable; matching at least one dog breed with at least one consumable; matching at least one breed code with at least one consumable; calculating standard units for at least one consumable; manufacturing at least one consumable; combining more than one consumable for daily intake by a dog; combining more than one consumable for daily intake by at least one dog breed; combining more than one consumable for daily intake by at least one breed code; calculating the quantity of at least one consumable to provide to at least one dog daily; calculating the quantity of at least one consumable to provide to at least one dog in a dog breed daily; calculating the quantity of at least one consumable to provide to at least one dog in a breed code daily; determining the average energy requirement for at least one dog; determining the average energy requirement for at least one dog breed; and determining the average energy requirement for at least one breed code.

Specifically, the foregoing methods described may become systems by providing at least one consumable pursuant to the method.

The methods and systems utilizing the calculation of an AER for at least one breed code may easily be applied to ascertain the AER for at least one individual dog, at least one dog breed and/or at least one breed code because the method utilizes an AER calculation that utilizes a breed code that creates a single indicia or value for individual dogs within the breed code, dog breeds within the breed code and the breed code itself. Similarly, the methods and systems described may be used to match an individual dog, at least one dog of a dog breed and/or at least one dog in a breed code with at least one consumable and/or a combination of consumables or to calculate the amount of at least one consumable and/or combination of consumables to daily provide to an individual dog, at least one dog of a dog breed and/or at least one dog in a breed code. Also similarly, in the manufacturing process, a manufacturer of consumables may apply the methods and systems utilizing the calculation of an AER for at least one breed code to ascertain the AER for an individual dog, at least one dog of a dog breed, at least one dog in a breed code, at least one dog breed and/or at least one breed code. In addition, in the manufacturing process, a manufacturer may use the methods and systems described to match an individual dog, at least one dog of a dog breed, at least one dog in a breed code, at least one dog breed and/or at least one breed code with at least one consumable and/or a combination of consumables or to calculate the amount of at least one consumable and/or combination of consumables to daily provide to an individual dog, at least one dog of a dog breed, at least one dog in a breed code, at least one dog breed and/or at least one breed code.

Although the invention has been illustrated by reference to specific embodiments, it will be apparent to those of ordinary skill in the art that various changes and modifications may be made which clearly fall within the scope of the invention. The invention is intended to be protected broadly within the spirit and scope of the appended claims.

What is claimed is:

1. A method of matching at least one dog with at least one consumable comprising the steps of
a. assigning a breed code to a plurality of breeds of dogs based on predetermined criteria;
b. categorizing said at least one consumable for said plurality of breeds of said dog assigned to said breed code, said categorizing of said at least one consumable further comprising ascertaining the average energy requirement for said breed code.

2. The method of claim 1, said predetermined criteria comprising a weight factor and an exercise factor with said weight factor being a numerical weight factor and said exercise factor being a numerical exercise factor, said predetermined manner for combining said exercise factor and said weight factor comprising the addition of said exercise factor and said weight factor.

3. The method of claim 1, said method further comprising publishing said assignment of said breed code and said categorization of said at least one consumable to allow the appropriate matching of said at least one consumable to said breed of said at least one dog.

4. The method of claim 1, said method further comprising ascertaining the caloric content in said at least one consumable and dividing said average energy requirement by said caloric content.

5. The method of claim 1, wherein said at least one consumable is comprised of at least one ingestible product.

6. The method of claim 1, wherein said at least one consumable is comprised of at least one quantity of an ingestible product.

7. The method of claim 1, said method further comprising placing indicia on said at least one consumable or on a container therefor, or on any means in the proximity thereof, that indicates its compatibility with said dog having the same indicia or a corresponding indicia.

8. The method of claim 7, said indicia comprising a breed code.

9. The method of claim 1, said average energy requirement being based on the average weight of adult dogs within said breed code.

10. The method of claim 9, said method further comprising determining said average energy requirement for said breed code by converting said average weight into kilograms and multiplying said average weight in kilograms by a metabolizable energy requirement constant factor.

11. The method of claim 10, said metabolizable energy requirement constant factor being 121.

12. The method of claim 1, said method further comprising converting said caloric content of said at least one consumable into standard units.

13. The method of claim 12, said method further comprising dividing said average energy requirement by said caloric content of said at least one consumable.

14. The method of claim 13, said average energy requirement and said caloric content being measured in kilocalories.

15. The method of claim 14, said method further comprising multiplying by 100 the result of said dividing of said average energy requirement by said caloric content of said at least one consumable.

16. The method of claim 1, said method further comprising converting said average energy requirement into kilocalories.

17. The method of claim 16, said method further comprising ascertaining one percent of said kilocalories.

18. The method of claim 17, said method further comprising designating said one percent as a standard unit.

19. A method of matching at least one dog breed with at least one consumable comprising the steps of
a. assigning a breed code to a plurality of breeds of dogs based on predetermined criteria;
b. categorizing said at least one consumable for said plurality of breeds of said dog assigned to said breed code, said categorizing of said at least one consumable further comprising ascertaining the average energy requirement for said breed code.

20. A system of matching at least one dog with at least one consumable comprising the steps of
a. assigning a breed code to a plurality of breeds of dogs based on predetermined criteria;
b. categorizing said at least one consumable for said plurality of breeds of said dog assigned to said breed code, said categorizing of said at least one consumable further comprising ascertaining the average energy requirement for said breed code; and
c. providing said at least one consumable.

21. A system of matching at least one dog breed with at least one consumable comprising the steps of
a. assigning a breed code to a plurality of breeds of dogs based on predetermined criteria;
b. categorizing said at least one consumable for said plurality of breeds of said dog assigned to said breed code, said categorizing of said at least one consumable further comprising ascertaining the average energy requirement for said breed code; and
c. providing said at least one consumable.

22. A method of matching at least one breed code with at least one consumable comprising the steps of categorizing said at least one consumable for said breed code, said categorizing of said at least one consumable further comprising ascertaining the average energy requirement for said breed code.

23. A system of matching at least one breed code with at least one consumable comprising the steps of:
a. categorizing said at least one consumable for said at least one breed code, said categorizing of said at least one consumable further comprising ascertaining the average energy requirement for said at least one breed code; and
b. providing said at least one consumable.

24. A method of calculating standard units for at least one consumable, said method comprising:
a. determining at least one breed code for at least one breed of dog;
b. calculating the average energy requirement for said at least one breed code.

25. The method of claim 24, where 100 standard units equal said average energy requirement.

26. The method of claim 24, said method further comprising:
a. converting said average energy requirement into kilocalories;
b. ascertaining one percent of said kilocalories; and
c. designating said one percent as a standard unit.

27. The method of claim 24, said method further comprising
a. determining the caloric content in said at least one consumable and
b. dividing said average energy requirement by said caloric content in said at least one consumable.

28. The method of claim 27, said method further comprising providing more than one consumable, and adding said more than one consumable so that said standard units equal said average energy requirement.

29. The method of claim 27, where said caloric content is measured in kilocalories.

30. The method of claim 29, said at least one consumable further comprising at least one administrable product.

31. The method of claim 30, said at least one consumable further comprising at least one ingestible product.

32. The method of claim 31, said method further comprising adding said more than one ingestible product so that said standard units equal said average energy requirement.

33. A method of manufacturing at least one consumable, said method comprising:
a. determining at least one breed code for at least one breed of dog;
b. calculating the average energy requirement for said at least one breed code;
c. determining the caloric content in said at least one consumable.

34. The method of claim 33, said method further comprising determining standard units by dividing said average energy requirement by said caloric content in said at least one consumable.

35. The method of claim 33, said at least one consumable further comprising more than one consumable.

36. The method of claim 33, said at least one consumable comprising at least one administrable product.

37. The method of claim 33, said at least one consumable further comprising at least one ingestible product.

38. The method of claim 33, said method further comprising having 100 standard units equaling said average energy requirement.

39. A system of manufacturing at least one consumable, said method comprising:
a. determining at least one breed code for at least one breed of dog;
b. calculating the average energy requirement for said at least one breed code;
c. determining the caloric content in said at least one consumable; and
d. manufacturing said at least one consumable.

40. A method of matching at least one dog with at least one consumable comprising the steps of
a. assigning at least one breed code to a plurality of breeds of dogs based on predetermined criteria;
b. calculating the average energy requirement for said plurality of breeds using the average weight of adult dogs within said breed code; and
c. converting said at least one consumable into standard units.

41. The method of claim 40, said method further comprising determining number of standard units that will provide 100 percent of said average energy requirement for said breed code.

42. A method of matching at least one dog breed with at least one consumable comprising the steps of
a. assigning at least one breed code to a plurality of breeds of dogs based on predetermined criteria;
b. calculating the average energy requirement for said plurality of breeds using the average weight of adult dogs within said breed code; and
c. converting said at least one consumable into standard units.

43. A method of matching at least one dog with at least one consumable comprising the steps of
a. assigning at least one breed code to a plurality of breeds of dogs based on predetermined criteria;
b. calculating the Average Energy Requirement for said plurality of breeds using a Metabolizable Energy Requirement equation that has a constant factor of 121 times the average weight of adult dogs within said at least one breed code;
c. calculating a standard unit as one percent of the average energy requirement of said at least one breed code;
d. converting said at least one consumable into standard units;
e. providing 100 percent of said average energy requirement to said at least one dog per day.

44. A method of matching at least one dog breed with at least one consumable comprising the steps of:
a. assigning at least one breed code to a plurality of breeds of dogs based on predetermined criteria;
b. calculating the Average Energy Requirement for said plurality of breeds using a Metabolizable Energy Requirement equation that has a constant factor of 121 times the average weight of adult dogs within said at least one breed code;
c. calculating a standard unit as one percent of the average energy requirement of said at least one breed code;
d. converting said at least one consumable into standard units;
e. providing 100 percent of said average energy requirement to said at least one dog breed per day.

45. A method of matching at least one dog breed with at least one consumable comprising the steps of
a. assigning a breed code to a plurality of breeds of dogs based on predetermined criteria, said predetermined criteria for assigning said breed code to said plurality of breeds of said dog comprising: assigning an exercise factor to each of said breeds of said dog based on predetermined criteria; assigning a weight factor to each of said breeds of said dog based on predetermined criteria, and; combining said exercise factor and said weight factor in a predetermined manner to determine said breed code;
b. categorizing at least one consumable for said plurality of dog breeds assigned to said at least one breed code;
c. publishing said assignment of said at least one breed code and said categorization of said at least one consumable to allow a consumer to match said at least one consumable to said at least one breed of dog.

46. A method of combining more than one consumable for daily intake by a dog, said method comprised of:
a. determining a breed code for said dog;
b. determining the average energy requirement for said breed code;
c. converting said average energy requirement into standard units;
d. determining caloric content in each of said more than one consumable;
e. converting said caloric content in each of said more than one consumable into standard units;
f. combining said more than one consumable in a manner in which said standard units in said more than one consumable equal a predetermined value.

47. A method of combining more than one consumable for daily intake by at least one dog breed, said method comprised of:
a. determining at least one breed code for said at least one dog breed;
b. determining the average energy requirement for said at least one breed code;
c. determining the caloric content in each of said more than one consumable;
d. converting said caloric content in each of said more than one consumable into standard units based on said average energy requirement;
e. combining said more than one consumable in a manner in which said standard units in said more than one consumable equal a predetermined value.

48. A method of calculating the quantity of at least one consumable to provide to at least one dog for consumption daily, said method comprising:
a. ascertaining the breed code for said at least one dog based on predetermined criteria;
b. determining the average energy requirement for said breed code;
c. determining the caloric content in a quantity of said at least one consumable; and
d. dividing said average energy requirement by said caloric content of said at least one consumable.

49. A method of calculating the quantity of at least one consumable to provide to at lease one dog breed for consumption daily, said method comprising:
a. ascertaining the breed code for said at least one dog breed based on predetermined criteria;
b. determining the average energy requirement for said breed code;
c. determining the caloric content in a quantity of said at least one consumable; and
d. dividing said average energy requirement by said caloric content of said at least one consumable.

50. A method of calculating the quantity of at least one consumable to provide to at least one breed code for consumption daily, said method comprising:
a. determining the average energy requirement for said breed code;
b. determining the caloric content in a quantity of said at least one consumable; and
c. dividing said average energy requirement by said caloric content of said at least one consumable.

51. A method of determining the average energy requirement for at least one breed code, said method comprising:
a. calculating the average weight of average adult dogs in said at least one breed code;
b. multiplying said average weight by a metabolizable energy requirement constant factor.
